(19) United States
(12) Patent Application Publication
(10) Pub. No.: US 2002/0189549 A1
(43) Pub. Date: Dec. 19, 2002

(54) Cat scratching system

(76) Inventors: Tya B. Writer, New York, NY (US); Julie A. Writer, New York, NY (US)

Correspondence Address: Michael S. Neustel, Suite No. 4, 2534 South University Drive, Fargo, NC, 58103, US

(21) Appl. No.: 09/875,372

(22) Filed: Jun. 5, 2001

(51) Int. Cl. A01K 15/02

(52) U.S. Cl. 119/706

(57) ABSTRACT

A cat scratching system for providing a convenient location for cats to exert their scratching urges without damaging surrounding property. The cat scratching system includes a floor mat positionable upon a horizontal surface such as a floor, and a wall mat attachable to a vertical surface such as a wall. The floor mat includes a lower gripping surface for gripping the horizontal surface and a first engaging surface for engagement by the claws of the rear paws of the cat. The wall mat includes an adhesive for securing the wall mat to the vertical surface and a second engaging surface for engagement by the claws of the front paws of the cat. The wall mat may also be attached to the vertical surface with conventional fasteners independently or in conjunction with the adhesive.

### BACKGROUND OF THE INVENTION

1. Field of the Invention

The present invention relates generally to cat scratching devices and more specifically it relates to a cat scratching system for providing a convenient location for cats to exert their scratching urges without damaging surrounding property.

2. Description of the Prior Art

Cat scratch devices have been in use for years. Typically, a conventional cat scratching device is comprised of a solid object surrounded within carpeting such as a “scratching post” or a block structure.

The main problem with conventional cat scratching devices is that they require a significant amount of space within an interior of a home. Another problem with conventional cat scratching devices is that they are a separate structure from the interior of the home and therefore the cat may find scratching familiar structures more attractive. Another problem with conventional cat scratching devices is that the cat often times moves the scratching device during their scratching actions.

Examples of patented cat scratching devices which are illustrative of such prior art include U.S. Pat. No. 5,592,901 to Birmingham; U.S. Pat. No. 5,247,902 to Williams; U.S. Pat. No. 5,474,026 to Wohltjen; U.S. Pat. No. 5,619,953 to Griffin; U.S. Pat. No. 5,775,263 to Richards; U.S. Pat. No. 3,482,548 to Burns; U.S. Pat. No. 295,088 to O'Rourke; U.S. Pat. No. 4,996,946 to Olson.

While these devices may be suitable for the particular purpose to which they address, they are not as suitable for providing a convenient location for cats to exert their scratching urges without damaging surrounding property. Conventional cat scratching devices require a significant amount of space within an interior of a home and are easily moved by the cat.

In these respects, the cat scratching system according to the present invention substantially departs from the conventional concepts and designs of the prior art, and in so doing provides an apparatus primarily developed for the purpose of providing a convenient location for cats to exert their scratching urges without damaging surrounding property.

### SUMMARY OF THE INVENTION

In view of the foregoing disadvantages inherent in the known types of cat scratching devices now present in the prior art, the present invention provides a new cat scratching system construction wherein the same can be utilized for providing a convenient location for cats to exert their scratching urges without damaging surrounding property.

The general purpose of the present invention, which will be described subsequently in greater detail, is to provide a new cat scratching system that has many of the advantages of the cat scratching devices mentioned heretofore and many novel features that result in a new cat scratching system which is not anticipated, rendered obvious, suggested, or even implied by any of the prior art cat scratching devices, either alone or in any combination thereof.

To attain this, the present invention generally comprises a floor mat positionable upon a horizontal surface such as a floor, and a wall mat attachable to a vertical surface such as a wall. The floor mat includes a lower gripping surface for gripping the horizontal surface and a first engaging surface for engagement by the claws of the rear paws of the cat. The wall mat includes an adhesive for securing the wall mat to the vertical surface and a second engaging surface for engagement by the claws of the front paws of the cat. The wall mat may also be attached to the vertical surface with conventional fasteners independently or in conjunction with the adhesive.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a cat scratching system that will overcome the shortcomings of the prior art devices.

A second object is to provide a cat scratching system for providing a convenient location for cats to exert their scratching urges without damaging surrounding property.

Another object is to provide a cat scratching system that satisfies and relieves a cat's urges to scratch.

An additional object is to provide a cat scratching system that occupies a minimal amount of space within a home.

A further object is to provide a cat scratching system that is unobtrusive and aesthetically pleasing for the interior of a home.

Another object is to provide a cat scratching system that will not be moved by the scratching actions of a cat.

A further object is to provide a cat scratching system that may be easily removed and reattached in a different location within a home.

Another object is to provide a cat scratching system that saves a home owner money in costly furniture repairs.

A further object is to provide a cat scratching system that allows a cat to stretch their body and provide a limited amount of exercise.

Another object is to provide a cat scratching system that is easily adjusted based upon the size of the cat.

Another object is to provide a cat scratching system that simultaneously provides a broad scratching area for a cat's front paws and rear paws.

A further object is to provide a cat scratching system that encourages cats to stand upon their hind legs.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached to a wall and to the floor with a cat standing upright upon the floor mat.

FIG. 2 is an upper perspective view of the present invention attached to a wall and the floor.

FIG. 3 is a top view of the floor mat.

FIG. 4 is a bottom view of the floor mat.

FIG. 5 is a rear upper perspective view of the wall mat disclosing the adhesive underneath the protective covering.

### DESCRIPTION OF THE PREFERRED EMBODIMENT

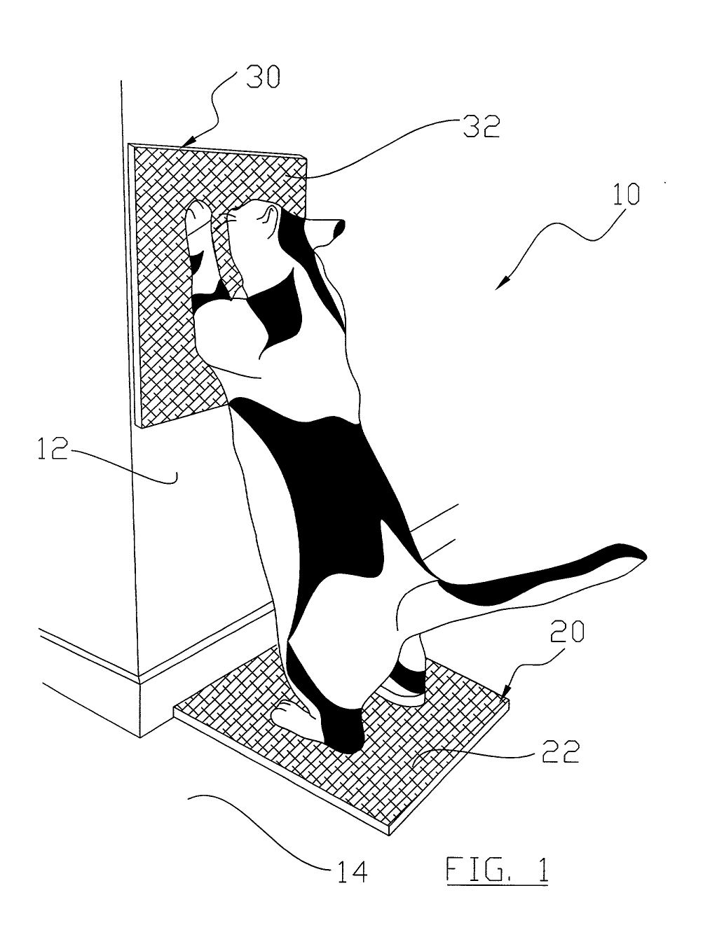

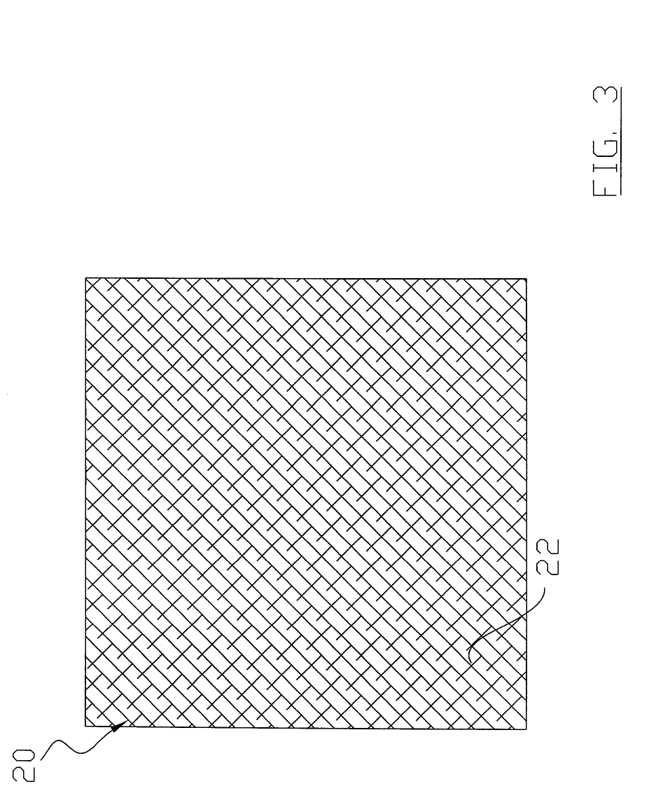

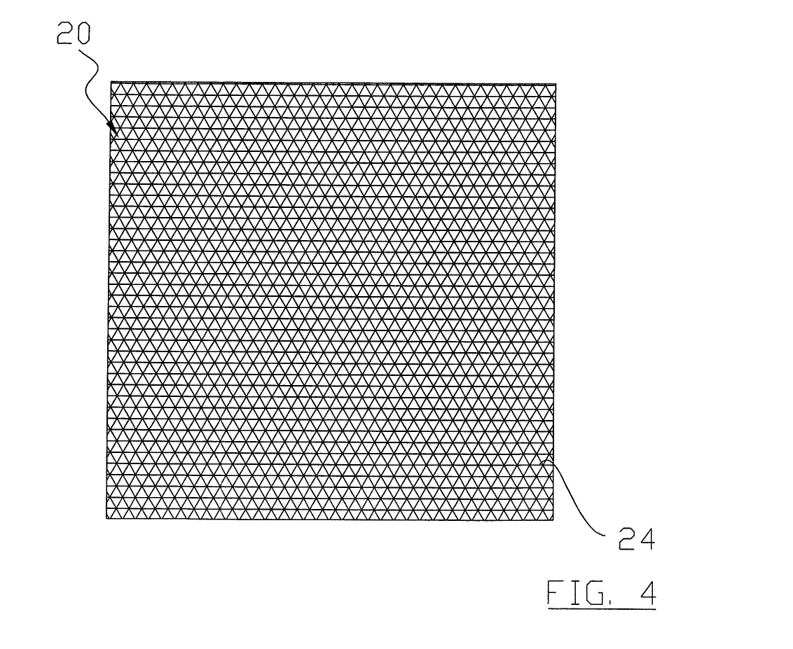

Turning now descriptively to the drawings, in which similar reference characters denote similar elements throughout the several views, FIGS. 1 through 5 illustrate a cat scratching system 10, which comprises a floor mat 20 positionable upon a horizontal surface 14 such as a floor, and a wall mat 30 attachable to a vertical surface 12 such as a wall. The floor mat 20 includes a lower gripping surface 24 for gripping the horizontal surface 14 and a first engaging surface 22 for engagement by the claws of the rear paws of the cat. The wall mat 30 includes an adhesive 34 for securing the wall mat 30 to the vertical surface 12 and a second engaging surface 32 for engagement by the claws of the front paws of the cat. The wall mat 30 may also be attached to the vertical surface 12 with conventional fasteners independently or in conjunction with the adhesive 34.

As shown in FIGS. 1 through 4 of the drawings, the floor mat 20 is comprised of a flat structure. The floor mat 20 is preferably comprised of a square shape, however various other shapes may be utilized to construct the floor mat 20 such as but not limited to circular, rectangular and oval. The first engaging surface 22 of the floor mat 20 is preferably comprised of a material commonly utilized within conventional scratching devices such as but not limited to a carpeting structure. The first engaging surface 22 preferably is comprised of a plurality of rows that are preferably positioned parallel to a plane of the wall mat 30.

The floor mat 20 further includes a lower gripping surface 24 opposite of the first engaging surface 22. The gripping surface 24 is comprised of a material that grips the horizontal surface 14 such as but not limited to rubber. The gripping surface 24 prevents movement of the floor mat 20 during usage by the cat.

As shown in FIGS. 1, 2 and 5 of the drawings, the wall mat 30 is comprised of a flat structure similar to the floor mat 20. The wall mat 30 is preferably comprised of a square shape, however various other shapes may be utilized to construct the wall mat 20 such as but not limited to circular, rectangular and oval. The second engaging surface 32 of the wall mat 30 is preferably comprised of a material commonly utilized within conventional scratching devices such as but not limited to a carpeting structure. The second engaging surface 32 preferably is comprised of a plurality of rows that are preferably positioned parallel to a plane of the floor mat 20 and the horizontal surface 14.

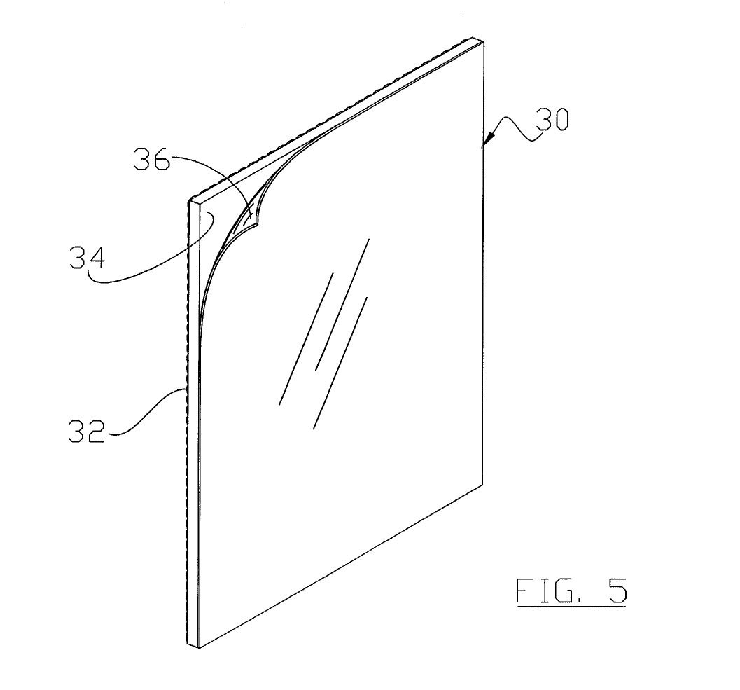

The wall mat 30 further includes an adhesive 34 opposite of the second engaging surface 32 as best illustrated in FIG. 5 of the drawings. The adhesive 34 is comprised of any well known composition that is able to securely attach the wall mat 30 to the vertical surface 12 without movement or removal during usage by the cat. A protective covering 36 is preferably positioned about the adhesive 34 prior to installation for preventing sticking to undesirable objects and surfaces.

The wall mat 30 may also be attached to the wall with conventional fasteners such as but not limited to nails and screws. If conventional fasteners are utilized, the protective covering 36 may remain upon the wall mat 30 to protect the vertical surface 12 from damage that could potentially be caused by the adhesive 34. However, the user may desire to secure the wall mat 30 with both the adhesive 34 and the conventional fasteners to ensure that the wall mat 30 will not be removed during usage.

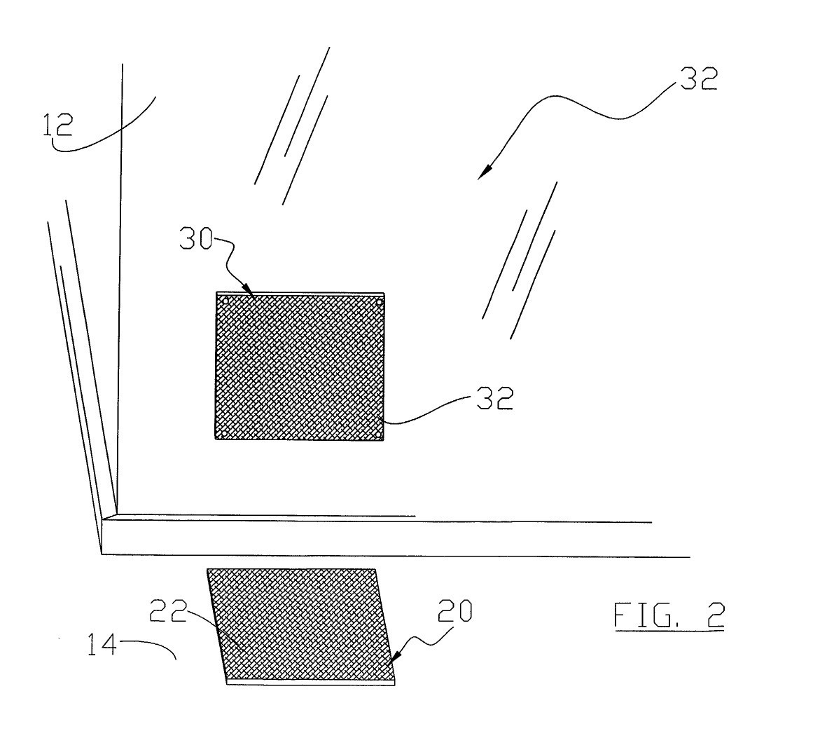

In use, the user first determines the height upon the vertical surface 12 to place the wall mat 30 based upon the size of the cat. After determining the height at which to place the wall mat 30, the user then determines whether conventional fasteners will be utilized to secure the wall mat 30 to the vertical surface 12. If conventional fasteners are to be utilized, the user may not have to remove the protective covering 36 for using the adhesive 34 which can severely damage the vertical surface 12. If the user decides to utilize the adhesive 34 for securing the wall mat 30, the user then removes the protective covering 36 and then positions the wall mat 30 in the desired location based upon the size of the cat. The user then positions floor mat 20 upon the horizontal surface 14 below the wall mat 30 as illustrated in FIGS. 1 and 2 of the drawings so that the cat can place their rear paws upon the floor mat 20 and their front paws upon the wall mat 30. The cat is thereafter free to utilize the floor mat 20 and/or the wall mat 30 as they desire without damaging objects within the home. The user may also remove and reattach the floor mat 20 and the wall mat 30 at anytime when desired.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for Cat Scratching System

| | |
|---|---|
| [symbol] ENVIRONMENTAL ELEMENTS | [symbol] 40. |
| [symbol] | [symbol] 41. |
| [symbol] | [symbol] 42. |
| [symbol] | [symbol] 43. |
| [symbol] | [symbol] 44. |
| [symbol] | [symbol] 45. |
| [symbol] | [symbol] 46. |
| [symbol] | [symbol] 47. |
| [symbol] | [symbol] 48. |
| [symbol] | [symbol] 49. |
| [symbol] 10. Cat Scratching System | [symbol] 50. |
| [symbol] 11. | [symbol] 51. |
| [symbol] 12. Vertical Surface | [symbol] 52. |
| [symbol] 13. | [symbol] 53. |
| [symbol] 14. Horizontal Surface | [symbol] 54. |
| [symbol] 15. | [symbol] 55. |
| [symbol] 16. | [symbol] 56. |
| [symbol] 17. | [symbol] 57. |
| [symbol] 18. | [symbol] 58. |
| [symbol] 19. | [symbol] 59. |
| [symbol] 20. Floor Mat | [symbol] 60. |
| [symbol] 21. | [symbol] 61. |
| [symbol] 22. First Engaging Surface | [symbol] 62. |
| [symbol] 23. | [symbol] 63. |
| [symbol] 24. Gripping Surface | [symbol] 64. |
| [symbol] 25. | [symbol] 65. |
| [symbol] 26. | [symbol] 66. |
| [symbol] 27. | [symbol] 67. |
| [symbol] 28. | [symbol] 68. |
| [symbol] 29. | [symbol] 69. |
| [symbol] 30. Wall Mat | [symbol] 70. |
| [symbol] 31. | [symbol] 71. |
| [symbol] 32. Second Engaging Surface | [symbol] 72. |
| [symbol] 33. | [symbol] 73. |
| [symbol] 34. Adhesive | [symbol] 74. |
| [symbol] 35. | [symbol] 75. |
| [symbol] 36. Protective Covering | [symbol] 76. |
| [symbol] 37. | [symbol] 77. |
| [symbol] 38. | [symbol] 78. |
| [symbol] 39. | [symbol] 79. |

We claim:

1. A cat scratching system for allowing a cat to stand during scratching, comprising:
a floor mat having a first engaging surface and a gripping surface opposite of said first engaging surface positionable upon a horizontal surface; and
a wall mat having a second engaging surface and an adhesive layer opposite of said second engaging surface for securing said wall mat to a vertical surface.

2. The cat scratching system of claim 1, wherein said gripping surface is comprised of a frictionally engagable material.

3. The cat scratching system of claim 2, wherein said gripping surface is comprised of a rubber material.

4. The cat scratching system of claim 3, wherein said gripping surface has a reticulated surface structure.

5. The cat scratching system of claim 4, wherein said floor mat has a square shape.

6. The cat scratching system of claim 5, wherein said wall mat has a square shape.

7. The cat scratching system of claim 6, wherein said first engaging surface is comprised of a carpet material.

8. The cat scratching system of claim 7, wherein said second engaging surface is comprised of a carpet material.

9. The cat scratching system of claim 8, wherein said second engaging surface is comprised of a plurality of rows that are parallel to said horizontal surface.

10. The cat scratching system of claim 9, wherein said floor mat has a size equal to said wall mat.

11. The cat scratching system of claim 1, wherein said wall mat includes a protective covering removably attached about said adhesive layer.

12. The cat scratching system of claim 11, wherein said gripping surface is comprised of a frictionally engagable material.

13. The cat scratching system of claim 12, wherein said gripping surface is comprised of a rubber material.

14. The cat scratching system of claim 13, wherein said gripping surface has a reticulated surface structure.

15. The cat scratching system of claim 14, wherein said floor mat has a square shape.

16. The cat scratching system of claim 15, wherein said wall mat has a square shape.

17. The cat scratching system of claim 16, wherein said first engaging surface is comprised of a carpet material.

18. A method of installing a cat scratching system having a floor mat having a first engaging surface and a gripping surface, and a wall mat having a second engaging surface, an adhesive layer and a protective covering positioned about said adhesive layer, said method comprising the steps of:
(a) positioning said floor mat upon a horizontal surface adjacent to a vertical surface;
(b) determining a height of said wall mat upon said vertical surface based upon a size of a cat;
(c) removing said protective covering from said wall mat exposing said adhesive layer; and
(d) applying said wall mat with said adhesive layer engaging said vertical surface at said height.

19. The method of installing a cat scratching system of claim 18, including the step of inserting a plurality of fasteners into said wall mat.

20. A method of installing a cat scratching system having a floor mat having a first engaging surface and a gripping surface, and a wall mat having a second engaging surface, an adhesive layer and a protective covering positioned about said adhesive layer, said method comprising the steps of:
(a) positioning said floor mat upon a horizontal surface adjacent to a vertical surface;
(b) determining a height of said wall mat upon said vertical surface based upon a size of a cat; and
(c) securing said wall mat to said vertical surface at said height with a plurality of fasteners.
